(19) United States
(12) Patent Application Publication
(10) Pub. No.: US 2024/0386334 A1
(43) Pub. Date: Nov. 21, 2024

(54) SEQUENTIAL PREDICTIONS USING HIERARCHICAL FORECASTING MODELS

(71) Applicant: DeepMind Technologies Limited, London (GB)

(72) Inventor: Christopher Mattern, London (GB)

(21) Appl. No.: 18/668,101

(22) Filed: May 17, 2024

Related U.S. Application Data
(60) Provisional application No. 63/467,892, filed on May 19, 2023.

(51) Int. Cl. G06N 20/20

(52) U.S. Cl. CPC G06N 20/20

(57) ABSTRACT

Methods, systems, and apparatus, including computer programs encoded on computer storage media. for making sequential predictions using hierarchical forecasting models.

### CROSS-REFERENCE TO RELATED APPLICATION

This application claims priority to U.S. Provisional Application No. 63/467,892, filed on May 19, 2023. The disclosure of the prior application is considered part of and is incorporated by reference in the disclosure of this application.

### BACKGROUND

This specification relates to making predictions for sequential inputs.

For example, some systems make predictions for sequential inputs using machine learning models. In some of these examples, the machine learning models are trained using online learning.

### SUMMARY

This specification describes a system that generates a respective predicted output for each input in a sequence of inputs. Each input generally includes a respective set of features that belong to a feature space of possible features.

Generally, the system generates predicted outputs using data specifying a hierarchical partition of the feature space of possible features into a plurality of segments that each correspond to a respective subspace of the feature space.

More specifically, the system maintains a respective forecasting model for each of the partitions and, when a given input is received, generates a prediction for the given input using the model(s) for the partitions to which the input belongs.

Particular embodiments of the subject matter described in this specification can be implemented so as to realize one or more of the following advantages.

Sequential prediction is an important problem in machine learning and is required for many real-world applications.

However, many techniques that rely on machine learning to perform sequential predictions have no guarantee on whether good performance, e.g., in terms of the accuracy of the model's predictions, at a given time in a sequence will carry forward to later in time in the same sequence or to a different sequence that may be drawn from a different distribution than the sequences on which the model was trained. This makes many of these machine-learned models difficult to apply to real-world tasks that require accurate predictions with some guarantee of reliability.

This specification addresses these issues by using an approach that yields performance comparable to high capacity models and at the same time offers guarantees on the performance of the prediction. This makes the techniques particularly suitable for deploying in real-world applications.

In particular, by partitioning the feature space hierarchically, and then learning a respective forecasting model for each partition, the system can generate accurate predictions in a computationally-efficient manner, e.g., even when the individual forecasting models are computationally-efficient linear models. Moreover, the system can generate these predictions with guarantees on the “regret,” i.e., total loss, of the predictions made by the system for any given input sequence, e.g., an O (logT) regret for sequences of length T.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example sequential prediction system.

FIG. 1B shows an example of the partitioning of a feature space into segments.

FIG. 2 is a flow diagram of an example process for generating predicted outputs.

FIG. 3 is a flow diagram of an example process for updating the forecasting models.

FIG. 4 is a flow diagram of an example process for updating a forecasting model for an indivisible partition.

FIG. 5 is a flow diagram of an example process for updating a forecasting model for a divisible partition.

FIG. 6 shows an example of the performance of the described techniques.

Like reference numbers and designations in the various drawings indicate like elements.

### DETAILED DESCRIPTION

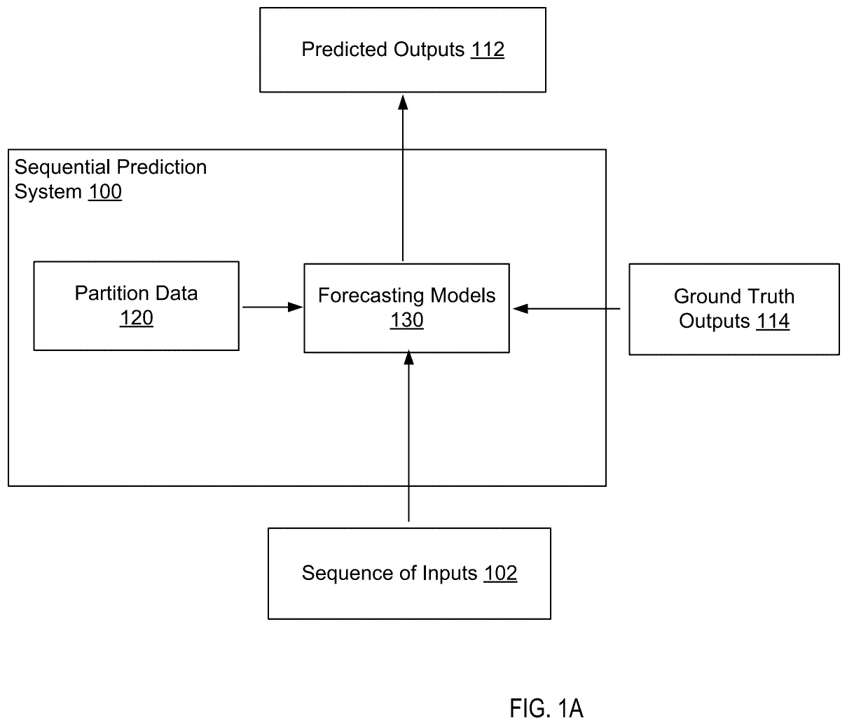

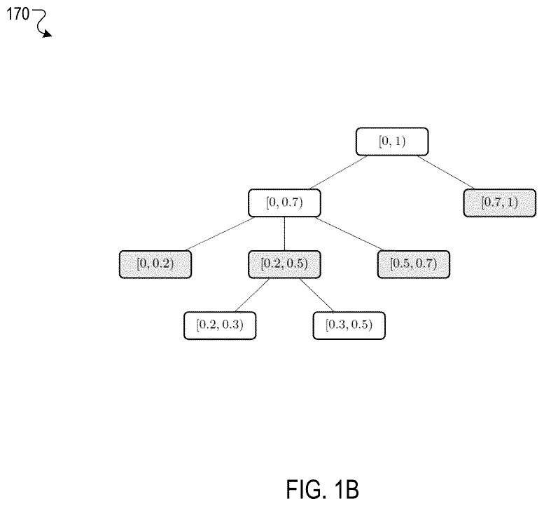

FIG. 1A shows an example sequential prediction system 100. The sequential prediction system 100 is an example of a system implemented as computer programs on one or more computers in one or more locations, in which the systems, components, and techniques described below can be implemented.

In particular, the system 100 generates a respective predicted output 112 for each input 102 in a sequence of inputs 102.

For example, the sequence of inputs 102 can be a “temporal” sequence so that each input 102 is received at a respective time step within the sequence.

Each input 102 generally includes a respective set of features 104 that belong to a feature space of possible features.

To generate the respective predicted outputs 112 for the inputs 102, the system 100 maintains partition data 120.

The partition data 120 specifies a hierarchical partition of the feature space of possible features into a plurality of segments that each correspond to a respective subspace of the feature space.

The partition is referred to as a “hierarchical” partition because some segments are divisible by other segments, i.e., a divisible segment has at least one segment that is a (proper) subset of the divisible segment, while some segments are indivisible, i.e., no other segment is a (proper) subset of the indivisible segment.

In this specification, a first segment divides a second segment if the first segment is a proper subset of the second segment and there is no other segment in the plurality of segments that satisfies both of the following conditions: 1) the first segment is a proper subset of the other segment and 2) the other segment is a proper subset of the second segment.

The system 100 can divide the feature space into segments in any of a variety of ways, depending on the structure of the inputs.

For example, one or more of the features in the input can correspond to a respective spatial location in a spatial representation of the feature space. In this example, each segment can correspond to a different spatial region in the spatial representation of the feature space. For example, for a two-dimensional representation, each input can include the x and y coordinates of the input in the representation, and the system can use these coordinates to generate the partition. As another example, for a three-dimensional representation, each input can include the x y and z coordinates of the input in the representation, and the system can use these coordinates to generate the partition.

As another example, each segment can correspond to a different node in a quad-tree decomposition of the feature space.

FIG. 1B shows an example 170 of a partitioning of the feature space. In the example 170, the system has partitioned the feature space based on possible values for a given feature that, in the example 170, span the continuous range [0,1), i.e., the range that includes zero and all values between zero and one, but does not include 1.

At a high level, the partitioning includes five indivisible segments: [0, 0.2), [0.2, 0.3), [0.3,.05), [0.5, 0.7), [0.7, 1.0). The partitioning also includes three divisible segments: [.2,.5), [0,.7), and [0,1).

In more detail, a segment S corresponds to a node of the tree shown in the example 170 and all segments dividing S correspond to the children of that node, e. g. the segments dividing [0, 0.7) are [0, 0.2), [0.2, 0.5), [0.5, 0.7), representing child nodes.

Consequently, if segment S corresponds to node u and segment S′ corresponds to node u′, then S′ C S translates to u′ being a descendant of u. For instance [0.2, 0.3)⊂[0, 0.7), hence represents a descendant.

Furthermore, divisible segments correspond to internal nodes and indivisible segments corresponds to leaf nodes, e. g. [0, 1), [0, 0.7) and [0.2, 0.5) represent the internal nodes and the remaining nodes represent the leaf nodes and therefore are indivisible segments.

More specifically, Segments {[0, 0.2), [0.2, 0.5), [0.5, 0.7), [0.7, 1)} (highlighted in gray) form a partition of [0, 1) which is a subset of the hierarchical partition from the above example, hence it is an induced partition. We have [0.2, 0.3) [[0.2, 0.5) ˜ [0, 0.7), hence segment [0.2, 0.3) doesn't divide [0, 0.7), but [0.2, 0.5) does.

There is no segment that divides [0.2, 0.3), hence this segment is indivisible.

In some implementations, the system can partition the feature space using a randomized hierarchical partition based on half-spaces. As one example, the partition can be generated as follows:

Consider a segment S, initially S=X⊆Rn. Given this segment, the system can draw vector a normally with mean 0 and unit variance I and draw b normally with mean μ and variance σ (note these are hyperparameters and may depend on S). There is a hyperplane

$$x \to \frac{{a}^{T}}{‖ a ‖} x - b$$

that divides S into halfspaces S1 and S2, which the system adds to the (intermediate) hierarchical partition. The system can now repeat this procedure recursively on S1 and S2 or stop if a stopping criterion is met, for instance if the number of recursion steps exceeds a threshold.

Returning to the description of FIG. 1A, the system 100 also maintains a respective forecasting model 130 for each partition, with the forecasting model 130 for each divisible portion being dependent on the outputs of the forecasting models 130 for the segments that divide the partition.

Thus, to generate the predicted output 112 at a given time step in the sequence, the system 100 determines which segment(s) of the feature space the input at the time step belongs to. The system 100 then generates a predicted output 112 for the input 102 at the time step based on the outputs of the forecasting model(s) 130 for the partition(s) of the feature space that the input 102 at the time step belongs to.

Generating predicted outputs for inputs is described in more detail below. After making a given prediction, i.e., after generating the predicted output 112, the system 100 can then receive, e.g., based on user input or data collected by sensors or data provided by another computer system, a ground truth output 114 for the time step.

The system 100 can use the output for the time step to update the forecasting models 130 through online learning.

Updating the forecasting models 130 through online learning is described in more detail below.

The system 100 can generate any of a variety of predicted outputs for any of a variety of input sequences.

For example, the input 102 at each time point can represent the weather in a geographical region and the predicted output 112 can be a prediction of the weather at the geographical region at a corresponding future time point, i.e., that is a fixed amount of time in the future relative to the time point.

As a particular example, the input 102 at each time point can represent precipitation, e.g., precipitation such as rainfall, hydrometeors, or both, in the geographical region and, optionally, in other geographical regions close to the geographical region, and the predicted output 112 can be a prediction of the precipitation that will be observed at the geographical region at the corresponding future time point.

While the above description describes that the system receives a single input at each time point, in practice the system can receive multiple different inputs at any a given time point. For example, in the weather example, the system may be asked to predict the weather at multiple different locations at a given time.

As another example, the input 102 at each time point can represent a sequence of text that has been received up to the time point and the predicted output 112 is a prediction of a text token that follows the last token in the sequence. That is, the system 100 can be used to perform a language modeling task. In some cases, the task can be a multi-modal language modeling task, where the sequence of text includes inputs from a modality other than text, e.g., images, the predicted outputs can be visual tokens or audio tokens, or both. More generally, the system can be used to make predictions for any of a variety of time series data.

A few non-limiting examples now follow.

For example, the input values can represent properties of electrical, mechanical, or electro-mechanical equipment and the task can be to predict future values of these properties. One example is when the time series values represent data collected from electricity transformers, e.g., load data or oil temperature or other state data, or other electrical equipment.

As another example, the time series values can represent electrical, water, gas, or other resource consumption of an entity, e.g., a household, a facility, or a company and the task can be to predict future values of these properties.

As another example, the time series values can represent properties of traffic on a roadway, e.g., road occupancy data, and the task can be to predict future values of these properties.

As yet another example, the time series values can represent exchange rates between currencies, and the task can be to predict future values of these properties.

As yet another example, the time series values can represent properties of a disease or other medical condition, e.g., the ratio of total patients seen that have the condition or other properties of the condition, and the task can be to predict future values of these properties.

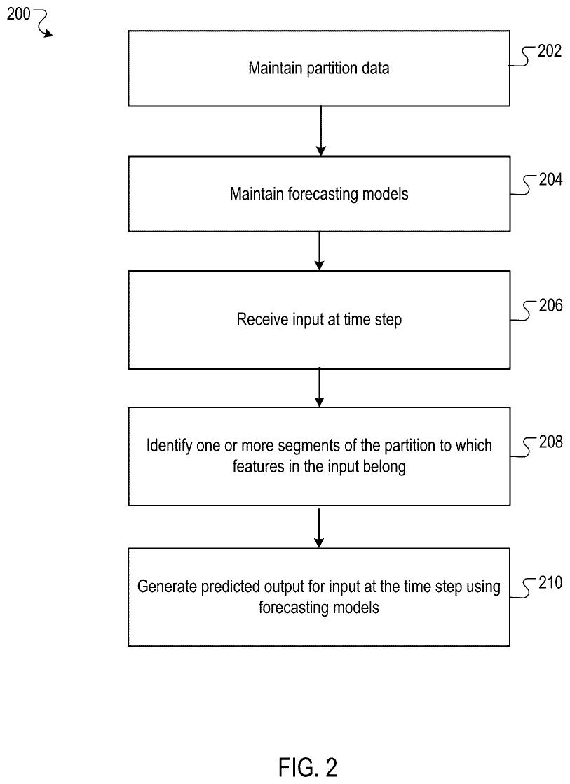

FIG. 2 is a flow diagram of an example process 200 for generating predicted outputs for inputs in a sequence. For convenience, the process 200 will be described as being performed by a system of one or more computers located in one or more locations. For example, a sequential prediction system, e.g., the sequential prediction system 100 of FIG. 1A, appropriately programmed, can perform the process 200.

The system maintains partition data specifying a hierarchical partition of a feature space of possible features (step 202).

The hierarchical partition includes a set of segments that each correspond to a respective subspace of the feature space.

Generally, the segments include (i) a plurality of divisible segments that are divided by one or more other segments in the set of segments and (ii) a plurality of indivisible segments that are not divided by any other segments in the plurality of segments.

The system maintains, for each segment of the hierarchical partition, a respective forecasting model (step 204).

Generally, the output of the respective forecasting model for each divisible segment depends on the input at the time step and respective outputs of the respective forecasting model for each segment that divides the segment.

The output of the respective forecasting model for each indivisible segment depends only on the input at the time step and not on outputs of any other forecasting models. In some implementations, the forecasting models are linear forecasting models. In these implementations, the respective forecasting model for each indivisible segment generates an output at least in part by performing an affine transformation between a set of weights for the respective forecasting model and the input at the time step.

For example, at a time step t, the output yₜ of the forecasting model for the indivisible segment can be represented as:

$${y}_{t} = {w}_{t - 1}^{T} {x}_{t} ,$$

where wₜ₋₁ are the weights of the forecasting model as of the time step, and where xₜ is the input at the time step t.

Similarly, the respective forecasting model for each divisible segment generates an output at least in part by computing an initial output by performing an affine transformation between a set of weights for the respective forecasting model and the input at the time and then modifying the initial output based on a respective output of the respective forecasting model for a particular segment that divides the divisible segment and to which the features in the input at the time step belong.

For example, the forecasting model can modify the initial output by computing a weighed sum between the initial output and the respective output of the respective forecasting model for a particular segment that divide the divisible segment and to which the features in the input at the time step belong. In this example, the weights in the sum are defined by a set of combining weights for the model.

For example, at a time step t, the output yₜ of the forecasting model for a divisible segment that is divided by another segment that has a forecasting model that has generated an output vₜ can be represented as:

$${u}_{t} = {w}_{t - 1}^{T} {x}_{t} , {y}_{t} = \frac{{β}_{t - 1}}{{1}^{T} {β}_{t - 1}} \cdot ( \begin{matrix}{u}_{t} \\ {v}_{t}\end{matrix} ) ,$$

where uₜ is the initial output, wₜ₋₁ are the base weights of forecasting model and βₜ₋₁ are the combining weights of the forecasting model as of the time step.

The system can perform steps 206-210 of the process 200 at each time step in the sequence to generate the predicted output for the input at the time step.

The system receives the input at the time step (step 206).

The system identifies one or more segments of the hierarchical partition to which the respective features in the input belong (step 208).

The system generates a predicted output for the input at the time step based on respective outputs generated by the respective forecasting models for each of the one or more segments to which the respective features in the input belong (step 210).

In particular, the system can generate a predicted output by recursively combining the predictions of the respective forecasters by traversing the hierarchical partition starting from the highest degree of specialization, i.e., the indivisible segments.

That is, the system first identifies which indivisible segment the input belongs to. The system processes the input using the forecasting model for the identified indivisible segment to generate an output.

The system then continues traversing the segments that the input belongs to along hierarchical partition until reaching a final segment to which the input belongs and that does not divide any other segments to which the input belongs. In this specification, the input belonging to a given partition means that the features in the input belong to the given partition.

For each traversed divisible segment, the system processes (i) the input and (ii) respective outputs of the respective forecasting model for each segment that divides the traversed segment using the forecasting model for the traversed segment to generate an output for the forecasting model.

The system then uses the output of the forecasting model for the final segment as the predicted output for the input.

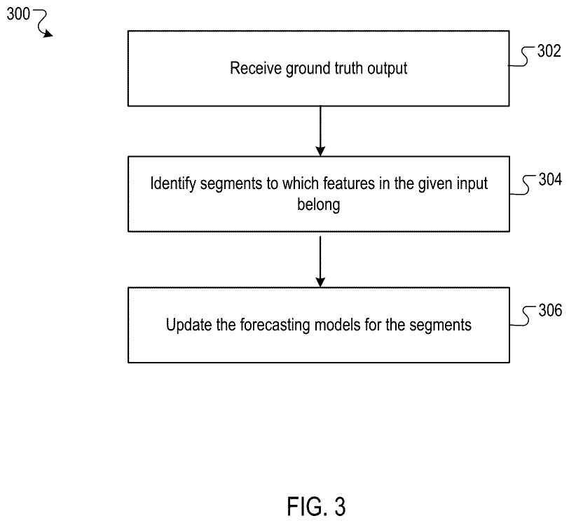

FIG. 3 is a flow diagram of an example process 300 for updating the forecasting models. For convenience, the process 300 will be described as being performed by a system of one or more computers located in one or more locations. For example, a sequential prediction system, e.g., the sequential prediction system 100 of FIG. 1A, appropriately programmed, can perform the process 300.

After generating the predicted output for a given input, the system receives a ground truth output for the input (step 302).

The system identifies the one or more segments to which the features in the given input belong (step 304).

The system updates the forecasting models for the segments using online learning based on the ground truth output (step 306).

More specifically, the system only updates the respective forecasting models for the one or more segments to which the features in the input belong.

Generally, the system updates these forecasting models through sequential learning.

As a particular example, the system can update the respective forecasting model for each of one or more segments to which the features in the input belong locally using a local loss that depends on the ground truth output and the output of the respective forecasting model. Thus, determining the loss does not require any computationally-expensive backpropagation calculations and can be computed efficiently.

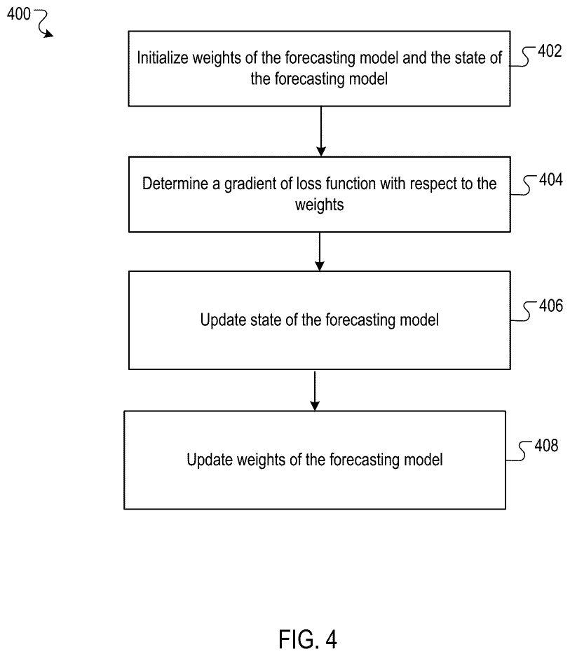

For example, when the forecasting models are linear models, the system can update the weights wₜ₋₁ of the forecasting model for the indivisible segment to which the features in the given input belong as described below with reference to FIG. 4.

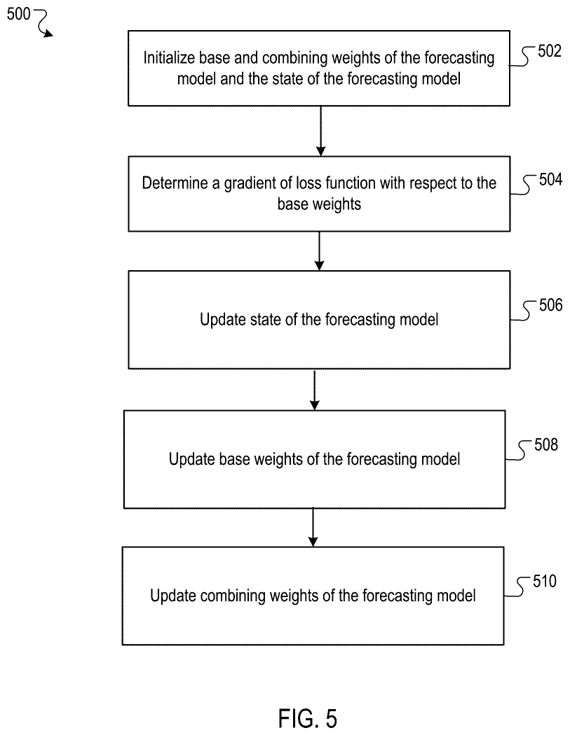

When the forecasting models are linear models, the system can update the base weights wₜ₋₁ and the combining weights βₜ₋₁ of the forecasting model for each divisible segment to which the features in the given input belong as described below with reference to FIG. 5.

FIG. 4 is a flow diagram of an example process 400 for updating the forecasting model for an indivisible segment. For convenience, the process 400 will be described as being performed by a system of one or more computers located in one or more locations. For example, a sequential prediction system, e.g., the sequential prediction system 100 of FIG. 1A, appropriately programmed, can perform the process 400.

Prior to the first time step in the sequence, the system initializes the weights of the forecasting model and the state of the forecasting model (step 402).

For example, the state of the forecasting model can include a state matrix A and a state vector b. In this example, the system can initialize the state matrix to a matrix of zeroes and initialize the state vector to a vector of zeroes. The system can initialize the weights in any appropriate way. For example, the system can initialize the weights by assigning each value in the weights to the same, fixed value.

The system can then perform steps 404-408 at each time step at which the input belongs to the indivisible segment.

The system determines a gradient ∇ₜ with respect to the weights of a loss function for the time step for the forecasting model (step 404).

As described above, the loss function is generally a local loss that depends only on the ground truth output and the output of the forecasting model. That is, the loss function measures an error between the ground truth output and the output of the forecasting model. For example, the loss function can be, e.g., a log loss, a mean squared error loss function, and so on.

In some cases, the loss function is the same function for all time steps while, in other cases, the loss functions can change across different time steps.

The system updates the state of the forecasting model using the gradient (step 406).

For example, the system can update the state matrix A as follows:

$${A}_{t} = {A}_{t - 1} + {∇}_{t} {∇}_{t}^{T} .$$

As another example, the system can update the state vector b as follows:

$${b}_{t} = {b}_{t - 1} + ( {∇}_{t}^{T} {w}_{t - 1} - \frac{1}{γ} ) \cdot {∇}_{t} ,$$

where γ is a hyperparameter of the system.

The system updates the weights of the forecasting model using the state of the forecasting model (step 408).

For example, the system can set the weights to the value that minimizes an approximation of the total loss up to the current time step. As a particular example, the system can update the weights as follows:

$${w}_{t} = arg {min}_{w} ( \frac{1}{2} {w}^{T} {A}_{t - 1} w - {b}_{t - 1}^{T} w ) .$$

FIG. 5 is a flow diagram of an example process 500 for updating the forecasting model for a divisible segment. For convenience, the process 500 will be described as being performed by a system of one or more computers located in one or more locations. For example, a sequential prediction system, e.g., the sequential prediction system 100 of FIG. 1A, appropriately programmed, can perform the process 500.

Prior to the first time step in the sequence, the system initializes the base weights of the forecasting model, the combining weights of the forecasting model, and the state of the forecasting model (step 502).

For example, as for the forecasting models for the indivisible segments, the state of the forecasting model can include a state matrix A and a state vector b. In this example, the system can initialize the state matrix to a matrix of zeroes and initialize the state vector to a vector of zeroes. The system can initialize the base weights and the combining weights in any appropriate way. For example, the system can initialize each value in the base weights to the same fixed value and can initialize the combining weights to each be equal to one half.

The system can then perform steps 404-410 at each time step at which the input belongs to the divisible segment.

The system determines a gradient ∇ₜ with respect to the base weights of a loss function for the time step for the forecasting model (step 404).

That is, the loss depends only on the initial output generated by the forecasting model at the time step (before the initial output is combined with any other outputs). As described above, the loss function is generally a local loss that depends only on the ground truth output and the initial output of the forecasting model. That is, the loss function measures an error between the ground truth output and the initial output of the forecasting model. For example, the loss function can be, e.g., a log loss, a mean squared error loss function, and so on.

In some cases, the loss function is the same function for all time steps while, in other cases, the loss functions can change across different time steps.

The system updates the state of the forecasting model using the gradient (step 506).

For example, the system can update the state matrix A as follows:

$${A}_{t} = {A}_{t - 1} + {∇}_{t} {∇}_{t}^{T} .$$

As another example, the system can update the state vector b as follows:

$${b}_{t} = {b}_{t - 1} + ( {∇}_{t}^{T} {w}_{t - 1} - \frac{1}{γ} ) \cdot {∇}_{t} .$$

The system updates the base weights of the forecasting model using the state of the forecasting model (step 508). For example, the system can set the base weights to the value that minimizes an approximation of the total loss up to the current time step. As a particular example, the system can update the base weights as follows:

$${w}_{t} = arg {min}_{w} ( \frac{1}{2} {w}^{T} {A}_{t - 1} w - {b}_{t - 1}^{T} w ) .$$

The system updates the combining weights of the forecasting model based on the loss function lₜ evaluated at the initial output, i.e., lₜ(uₜ), and the loss function evaluated at the output of the forecasting model for the segment that divides the divisible segment, i.e., lₜ(vₜ) (step 410).

For example, the system can update the combining weights as follows:

$${β}_{t} = ( \begin{matrix}( 1 - {α}_{t} ) {e}^{- η {l}_{t} ( {u}_{t} )} & {α}_{t} {e}^{- η {l}_{t} ( {v}_{t} )} \\ {α}_{t} {e}^{- η {l}_{t} ( {v}_{t} )} & ( 1 - {α}_{t} ) {e}^{- η {l}_{t} ( {v}_{t} )}\end{matrix} ) {β}_{t - 1} ,$$

where

$${α}_{t} = \frac{1}{t + 1}$$

and η is a fixed constant.

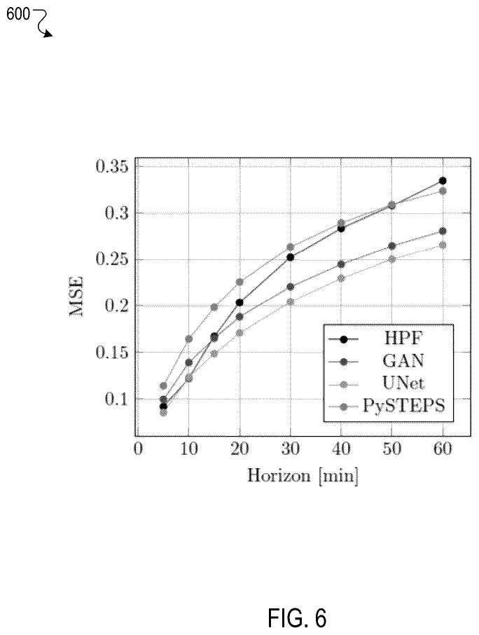

FIG. 6 shows an example 600 of the performance of the described techniques relative to a set of existing techniques on a weather forecasting task.

In particular, the example 600 shows the mean squared error (MSE) of each technique at different horizons (in minutes), where the horizon represents the delta between the current time at which the prediction is made and the time for which the prediction is made.

As can be seen from FIG. 6, the described techniques are competitive with a simulation-based forecaster (PySTEPS) and deep learning approaches (GAN and UNet), despite the described techniques using only a collection of linear forecasting models and therefore being significantly more computationally efficient.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.c., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
maintaining data specifying a hierarchical partition of a feature space of possible features, the hierarchical partition comprising a plurality of segments that each correspond to a respective subspace of the feature space;
maintaining, for each segment of the hierarchical partition, a respective forecasting model;
receiving a sequence of inputs, wherein each input comprises respective features that belong to the feature space of possible features,
for each input in the sequence:
identifying one or more segments of the hierarchical partition to which the respective features in the input belong; and
generating a predicted output for the input at the time step based on respective outputs generated by the respective forecasting models for each of the one or more segments to which the respective features in the input belong.

2. The method of claim 1, wherein:
the plurality of segments comprises a plurality of divisible segments that are divided by one or more other segments in the plurality of segments;
the plurality of segments comprises a plurality of indivisible segments that are not divided by any other segments in the plurality of segments; and
the respective forecasting model for each divisible segment depends on the input at the time step and respective outputs of the respective forecasting model for each segment that divides the segment.

3. The method of claim 2, wherein the respective forecasting model for each indivisible segment depends on the input at the time step and not on the respective outputs of the respective forecasting models for any other segments in the plurality of segments.

4. The method of claim 3, wherein the respective forecasting model for each indivisible segment generates an output at least in part by performing an affine transformation between a set of weights for the respective forecasting model and the input at the time step.

5. The method of claim 2, wherein the respective forecasting model for each divisible segment generates an output at least in part by:
computing an initial output by performing an affine transformation between a set of weights for the respective forecasting model and the input at the time step; and
computing a weighed sum between the initial output and a respective output of the respective forecasting model for a particular segment that divides the divisible segment and to which the features in the input at the time step belong.

6. The method of claim 1, further comprising:
for each input in the sequence:
receiving a ground truth output for the input; and
updating the forecasting models for the segments using online learning based on the ground truth output.

7. The method of claim 6, wherein updating the forecasting models for the segments using online learning based on the ground truth output comprises:
only updating the respective forecasting models for the one or more segments to which the features in the input belong.

8. The method of claim 6, wherein updating the forecasting models for the segments using online learning based on the ground truth output comprises:
updating the forecasting models through sequential learning.

9. The method of claim 6, wherein updating the forecasting models for the segments using online learning based on the ground truth output comprises:
updating the respective forecasting model for each of one or more segments to which the features in the input belong locally using a local loss that depends on the ground truth output and the output of the respective forecasting model.

10. The method of claim 1, wherein
each input in the sequence represents weather in a geographic region as of the time step; and
each predicted output is a prediction of weather in the geographic region at a corresponding future time step.

11. The method of claim 10, wherein:
each input in the sequence represents precipitation in a geographic region as of the time step; and
each predicted output is a prediction of precipitation in the geographic region at a corresponding future time step.

12. The method of claim 1, wherein the sequence of inputs are inputs to a language modeling task and each predicted output is an output for the language modeling task.

13. The method of claim 1, wherein each segment corresponds to a different spatial region in a spatial representation of the feature space.

14. The method of claim 1, wherein each segment corresponds to a different node in a quad-tree decomposition of the feature space.

15. A system comprising one or more computers and one or more storage devices storing instructions that when executed by the one or more computers cause the one more computers to perform operations comprising:
maintaining data specifying a hierarchical partition of a feature space of possible features, the hierarchical partition comprising a plurality of segments that each correspond to a respective subspace of the feature space;
maintaining, for each segment of the hierarchical partition, a respective forecasting model;
receiving a sequence of inputs, wherein each input comprises respective features that belong to the feature space of possible features,
for each input in the sequence:
identifying one or more segments of the hierarchical partition to which the respective features in the input belong; and
generating a predicted output for the input at the time step based on respective outputs generated by the respective forecasting models for each of the one or more segments to which the respective features in the input belong.

16. The system of claim 15, wherein:
the plurality of segments comprises a plurality of divisible segments that are divided by one or more other segments in the plurality of segments;
the plurality of segments comprises a plurality of indivisible segments that are not divided by any other segments in the plurality of segments; and
the respective forecasting model for each divisible segment depends on the input at the time step and respective outputs of the respective forecasting model for each segment that divides the segment.

17. The system of claim 16, wherein the respective forecasting model for each indivisible segment depends on the input at the time step and not on the respective outputs of the respective forecasting models for any other segments in the plurality of segments.

18. The system of claim 17, wherein the respective forecasting model for each indivisible segment generates an output at least in part by performing an affine transformation between a set of weights for the respective forecasting model and the input at the time step.

19. The system of claim 16, wherein the respective forecasting model for each divisible segment generates an output at least in part by:
computing an initial output by performing an affine transformation between a set of weights for the respective forecasting model and the input at the time step; and
computing a weighed sum between the initial output and a respective output of the respective forecasting model for a particular segment that divides the divisible segment and to which the features in the input at the time step belong.

20. One or more non-transitory computer storage media storing instructions that when executed by one or more computers cause the one more computers to perform operations comprising:
maintaining data specifying a hierarchical partition of a feature space of possible features, the hierarchical partition comprising a plurality of segments that each correspond to a respective subspace of the feature space;
maintaining, for each segment of the hierarchical partition, a respective forecasting model;
receiving a sequence of inputs, wherein each input comprises respective features that belong to the feature space of possible features,
for each input in the sequence:
identifying one or more segments of the hierarchical partition to which the respective features in the input belong; and
generating a predicted output for the input at the time step based on respective outputs generated by the respective forecasting models for each of the one or more segments to which the respective features in the input belong.
